(19) United States
(12) Patent Application Publication
(10) Pub. No.: US 2015/0336277 A1
(43) Pub. Date: Nov. 26, 2015

(54) INTERNAL GRIPPER

(71) Applicant: FIPA GmbH, Ismaning (DE)

(72) Inventor: Henning Schanz, Gilching (DE)

(21) Appl. No.: 14/718,348

(22) Filed: May 21, 2015

(30) Foreign Application Priority Data
May 26, 2014 (DE) 10 2014 210 011.9

(51) Int. Cl. B25J 15/00

(52) U.S. Cl. CPC B25J 15/0047; B25J 15/0028

(57) ABSTRACT

An internal gripper including an actuating cylinder (10) which has an actuating element (11) which, in particular, can be pneumatically or hydraulically extended or retracted at least in some regions in the axial direction (A) of the internal gripper (100) and that the internal gripper (100) furthermore has a gripper attachment (50) having a plurality of gripper jaws (51a-51f) which are disposed and designed in such a manner that a socket-shaped receiving area (55) is formed by the same, wherein the gripper attachment (50) is releasably connected to the actuating cylinder (10) such that the actuating element (11), at least in the extended state thereof, is received at least in some regions in the socket-shaped receiving area (55) and thereby presses the gripper jaws (51a-51f) outwards in the radial direction (R).

### CROSS REFERENCE TO RELATED APPLICATIONS

This application claims priority to German patent document DE102014210011.9 filed May 26, 2014, the entire contents of which are hereby incorporated by reference herein.

### BACKGROUND

The present invention relates to an internal gripper comprising an actuating cylinder for-pneumatic or hydraulic actuation of gripper jaws formed on the internal gripper.

Internal grippers which can be pneumatically or hydraulically actuated and comprise an actuating cylinder and gripper jaws which can be extended perpendicularly to the cylinder main axis at least in some regions in the radial direction are generally known. For example, an internal gripper comprising an actuating cylinder which can be pneumatically actuated is known from the German patent specification DE 100 60 405 A1. Gripper jaws are disposed on the periphery of the gripper, which are designed to be movable radially outwards with the aid of displacement surfaces that extend obliquely to the cylinder main axis by means of a thrust piece when compressed air is applied to an actuating piston.

In order to grip a hollow body, for example a pipe or something similar, such an internal gripper is inserted with the front end thereof, in which the jaws are movably designed, into the inside of this hollow body. In so doing, the jaws are extended by means of a corresponding actuation that is controlled by compressed air; thus enabling said jaws to exert a force on the inner walls of the hollow body which is directed radially outwards. When frictional forces are sufficiently large, a manipulation, for example a lifting or something similar, of the hollow body is provided while the internal gripper can simultaneously be handled in a simple manner.

Such known internal grippers have, however, the disadvantage that the stroke distance of the jaws which can be moved radially outwards and thus the achievable contact pressure at the hollow body of a certain volume or certain inner circumference is substantially determined by the radial stroke. If the radial stroke of the jaws is generously dimensioned, a control of the maximum contact pressing force of the jaws on the inner walls of the hollow body is thus required, in particular with hollow bodies that must be delicately handled. The control can, for example, be performed by means of a pressure regulation of the piston which is subjected to compressed air or also to hydraulic pressure. In other words, the conventional internal grippers have little flexibility with regard to the multiplicity of hollow bodies to be handled, which multiplicity is determined by the opening internal diameters and the mass of said hollow bodies and the like.

### SUMMARY

An aim underlying the present invention is to modify the internal gripper described above in such a way that the flexibility of application, in particular the geometric flexibility of the internal gripper is improved.

The aim may be met by an internal gripper which has an actuation cylinder, comprising an actuating element which can be pneumatically or hydraulically extended and retracted at least in some regions in the axial direction of the internal gripper, and a gripper attachment comprising a plurality of gripper jaws, which are disposed and designed in such a manner that a socket-shaped receiving area is formed by said gripper jaws, wherein the gripper attachment is releasably connected to the actuating cylinder such that the actuating element, at least in the extended state thereof, is received at least in some regions in the socket-shaped receiving area and thereby presses the gripper jaws radially outwards.

With respect to the conventional solutions, the internal gripper according to the invention has a number of advantages. Hence, the particular technical advantage results from, among other things, the fact that the actuating cylinder can be designed in a standardized manner due to the modularity, i.e. due to the releasable connection of the gripper attachment to said actuating cylinder; whereas the jaws which are arranged as an annulus are designed as a replaceable attachment. As a result, it is possible in a simple manner for the geometry of the internal gripper or, respectively, the stroke and contact pressure of the gripper jaws to be adapted to the dimensions of the object to be gripped. In so doing, it is in turn possible in a manner which can easily be implemented to adapt the geometry of the internal gripper to different objects to be gripped with respect to the hollow space thereof and, in fact, in a cost effective and material saving manner.

By virtue of the fact that only the gripper attachment comprising the plurality of gripper jaws and the socket-shaped receiving area thereof has to be adapted to the geometry of the object to be gripped, the actuating cylinder comprising the actuating element thereof, which can be extended and retracted at least in some regions and comprises a multiplicity of gripper attachments of varying design, can be used, which on the whole simplifies the variability and the adaptability.

Provision is thus, for example, made for the gripper jaws to be arranged circularly relative to one another, i.e. mutually form a circle or annulus, on average perpendicularly to the axial direction of the internal gripper. Said gripper jaws are hereby connected to one another via an annular base. In so doing, a particularly simple geometric design of the gripper attachment and a particularly simple replaceability result because the connection of the gripper jaws by means of the annular base prevents the replaceably designed gripper attachment from falling apart into the individual parts thereof. The manageability is thus improved overall.

According to a further aspect of the invention, provision is made for the internal gripper to further have a gripper housing designed as a cap nut. The housing is used to releasably connect the gripper attachment to the actuating cylinder. In one modification, the cap nut has, in addition to a thread which is designed in a complementary manner to a thread configured on the actuating cylinder, an end face which interacts with a pressing region of the annular base of the gripper attachment in such a manner that said end face fixedly presses the gripper attachment against the actuating cylinder when producing the connection to said actuating cylinder; thus enabling the retractable and extendable actuating element to be introduced securely and substantially free of play into the socket-shaped receiving area formed by the gripper jaws.

According to a further aspect of the invention, provision is made for the internal gripper to have at least one annular spring and, in particular, an annular spring formed from an elastomer, with which the gripper jaws are encompassed on the periphery thereof. When the actuating element is retracted, if applicable likewise by means of a spring device or something similar, to end a gripping or spreading operation of the jaws, such an annular spring ensures by means of the resilience thereof that the gripper jaws return to the unspread starting position to end the gripping operation. In particular in the case where the annular spring is formed from elastomer, such a return operation of the gripper jaws can be easily implemented.

According to a further aspect of the invention, provision is made for the socket-shaped receiving area formed by the gripper jaws to have a frustoconical contour at least in some regions in longitudinal cross section thereof. The taper angle is in this case preferably between 5 and 25° and in a more preferable manner between 10 and 15°. Such a frustoconical contour is used to guide the actuating element along the jaws and ensures that said jaws expand radially outwards. Through the selection of the taper angle, it is possible by means of the modular design of the internal gripper to adapt a corresponding gripper attachment of the internal gripper to a hollow body to be manipulated by varying the taper angle in a simple manner, for example with regard to the necessary radial stroke of the jaws or their contact pressing force on the inner walls of the hollow body.

In a preferred modification, provision is made in the case of such an internal gripper for the socket-shaped receiving area formed by the gripper jaws to furthermore have a region with a cylindrical contour in the longitudinal cross section thereof. This region extends substantially linearly as viewed in the axial direction of the internal gripper. By placing such a region that extends substantially linearly upstream of where the socket-shaped receiving area is beveled, it is assured that the actuating element, even then if a slight mechanical play exists between actuating cylinder and gripper attachment in the assembled state, carries out the actuation, i.e. the radial expansion of the gripper jaws, uniformly and in a manner that is easy to manipulate.

According to a further aspect of the invention, provision is made for the actuating element to be designed linearly in the direction of actuation with respect to the cylinder. In other words: the actuating element does not have substantially any angular faces in the direction of actuation, i.e. along the traverse path, in contrast to the angular faces of the frustoconical contour of the socket-shaped receiving area formed by the gripper jaws.

Such an actuating element is therefore designed in the simplest case substantially cylindrical according to this modification. As a result, the actuating element can be designed as a simple pin and be formed, for example, by the front part of a reciprocating piston. By virtue of the fact that no autonomous angular faces or a comparable complicated geometry may be necessary, this actuating element can be manufacturing comparatively simply, whereby the material and cost requirements are further reduced in comparison to conventional solutions.

According to a further aspect of the invention, the actuating movement of the actuating element for extending and retracting takes place linearly. The actuating movement preferably takes place in the direction of the cylinder main axis. A simple design of the actuating cylinder is possible by means of such a linear method comprising a substantially linear actuating movement of the actuating element, wherein the actuation itself can take place with a smooth and uniform movement. The clamping process of the gripper jaws in the interior of the hollow space of the object to be gripped likewise takes place uniformly in the case of such an actuating movement.

### BRIEF DESCRIPTION OF THE DRAWINGS

An exemplary embodiment of the internal gripper according to the invention is explained below in detail with the aid of the drawings.

In the drawings:

FIG. 1 shows a perspective exploded view of the internal gripper according to the invention in one embodiment of the invention;

FIG. 2 shows a technical sectional drawing of the assembled internal gripper according to the embodiment from FIG. 1; and

FIG. 3 shows in perspective view the assembled internal gripper according to the embodiment.

### DETAILED DESCRIPTION

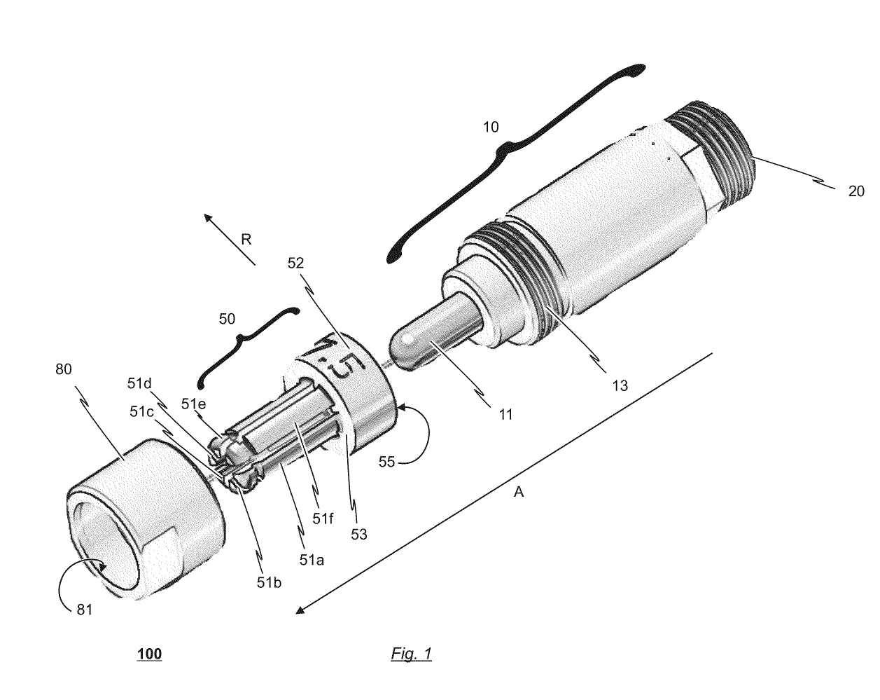

FIG. 1 shows a perspective exploded view of an inventive internal gripper 100 according to one embodiment of the invention.

The internal gripper 100 has an actuating cylinder 10 which has in turn a pin-shaped actuating element 11 that can be extended and retracted on the one end face thereof. Downstream of said actuating element, a connecting thread 13 is provided on the actuating cylinder 10 in the modular internal gripper. The function of said connecting thread will be explained in more detail below. A pressure admission connection 20 is provided for supplying fluid or compressed air, which are used to actuate the actuating element 11, at the other end face of the actuating cylinder 10.

During a corresponding application of pressure, the actuating element 11 of the actuating cylinder 10 can be displaced in the axial direction denoted with A of the internal gripper 100 towards a gripper attachment which in its entirety is denoted with the reference sign 50.

The gripper attachment 50 has a plurality of gripper jaws, in the exemplary embodiment in total six gripper jaws 51a, 51b, 51c, 51d, 51e, 51f. Said gripper jaws are designed annularly in a sectional plane that is perpendicular to the axial direction, i.e. in a sectional plane as seen in the radial direction R and are held together at the end of the gripper attachment 50 facing the actuating cylinder 10 by an annular base 52.

As a result of being held together by means of the annular base 52, a simple replaceability of the gripper attachment 50 is ensured while at the same time the actuating cylinder 10 is a standardized component in order to apply such a corresponding adaptability of the internal gripper 100 collectively to the hollow space geometries or, respectively, to the further material compositions and other variables, such as, for example, the mass of the hollow body to be manipulated.

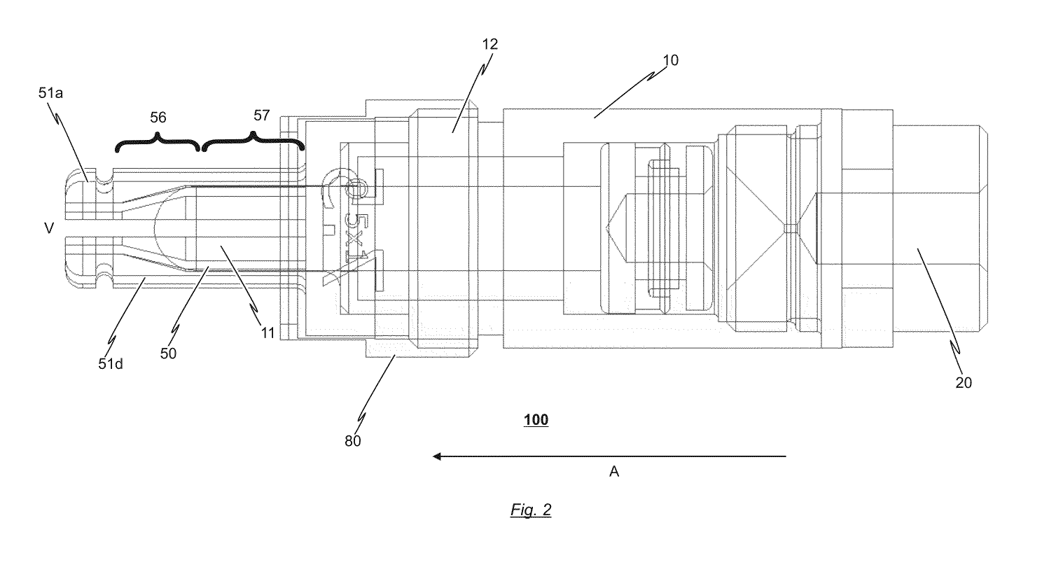

The gripper jaws 51a-51f form in turn a socket-shaped receiving area 55 for the retractable and extendable actuating element 11. The actuating process is explained in more detail below with reference to FIG. 2.

A cap nut 80 is additionally provided in the modularly designed internal gripper 100 for fixing the gripper attachment 50 to the actuating cylinder 10 according to the depicted exemplary embodiment, said cap nut being furnished in turn with an internal thread (not depicted) designed complementary to the connecting thread 13 of the actuating cylinder 10. In a corresponding screwing-on process of the cap nut 80, an end face 81 provided on the front end of the cap nut 80 presses against a pressing region 53 of the gripper attachment 50 in order to fix the gripper attachment 50 firmly and with as little play as possible on the actuating cylinder 10. As a result of the releasability of the connection, a later replacement of the gripper attachment 50, for example, for adapting the expansion length of the gripper jaws 51a-51f or the like is possible in a simple manner.

The principal functioning during an actuating process of the assembled inventive internal gripper 100 according to the exemplary embodiment can be seen from the depiction according to FIG. 2. As can be seen in the cross-sectional view depicted in FIG. 2, the gripper attachment 50 has a frustoconical region 56 in the region of the gripper jaws thereof, of which 51a and 51d can be seen in the cross-sectional view, at the front end V of the internal gripper 100. This frustoconical region, which extends with a taper angle of approximately 15° in the direction of the annular base 52 of the gripper attachment 50 when viewed from the front end V, leads into a cylindrical region 57, within which the walls of the gripper jaws 51a-51f extend substantially parallel to the axial direction A of the internal gripper 100, before reaching the annular base 52.

In the depiction in FIG. 2, that state of the assembled internal gripper 100 is shown in which the retractable and extendable actuating element 11 precisely comes into contact with the end of the frustoconical region 56 lying at the back; thus enabling the gripper jaws 51a-51f to begin to spread apart in the radial direction R when the actuating element 11 continues to extend in the direction of the front end V by means of pressure being applied to the actuating cylinder 10.

If the actuating element 11 is retracted out of the frustoconical region 56, an elastomer annular spring (not depicted) makes sure that the gripper jaws 51a-51f are pressed back into the starting position depicted in FIG. 2, i.e. into the non-expanded position. When said gripper jaws are retracted in such a manner, a gripping operation of a hollow body to be manipulated has concluded.

The cylindrical region 57 is used here to reliably guide the actuating element 11 which for its part is configured without its own angular faces, which simplifies the manufacture thereof. A good adaptability of the gripper attachment to the manipulation conditions is possible by means of a corresponding adaptation of the taper angle α and a corresponding shortening or lengthening of the cylindrical region 57.

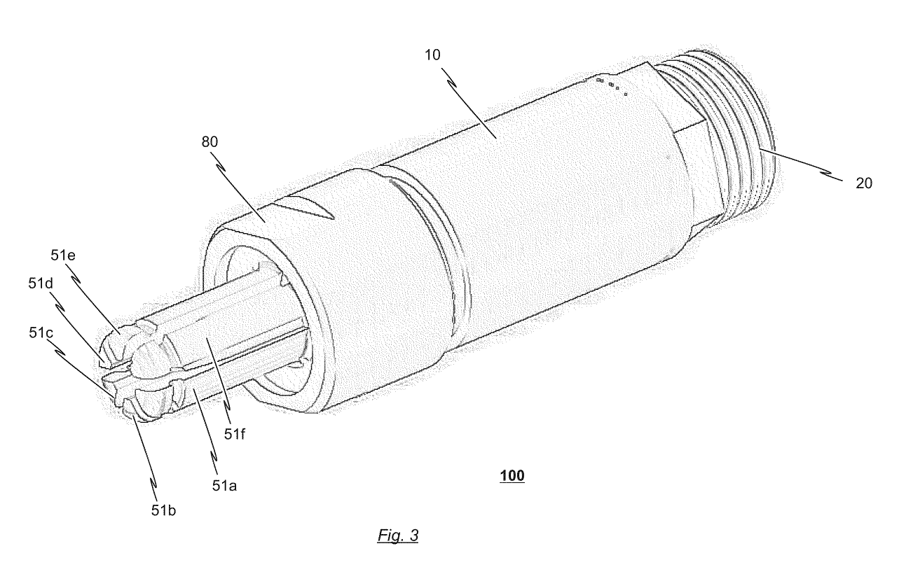

In conclusion, FIG. 3 shows in a perspective view the assembled internal gripper 100 according to an embodiment of the invention in the non-actuated, i.e. non-expanded, state of the gripper jaws.

### LIST OF REFERENCE SIGNS

10 actuating cylinder
11 actuating element
12 piston rod
13 connecting thread
20 pressure admission connection
50 gripper attachment
51a, 51b, 51c, 51d, 51e, 51f gripper jaw
52 annular base
53 pressing region
55 socket-shaped receiving area
56 frustoconical region
57 cylindrical region
80 cap nut
81 end face of the cap nut
100 internal gripper
A axial direction
V front end
R radial direction
α taper angle

1. An internal gripper (100) comprising:
an actuating cylinder (10) comprising an actuating element (11) which can be pneumatically or hydraulically moved to a retracted state or an extended state relative to an axial direction (A) of the internal gripper (100); and
a gripper attachment (50) comprising gripper jaws (51a, 51b, 51c, 51d, 51e, 51f) which are arranged such that a socket-shaped receiving area (55) is formed by the gripper jaws (51a, 51b, 51c, 51d, 51e, 51f),
wherein the gripper attachment (50) is releasably connected to the actuating cylinder (10) such that the actuating element (11) is received at least partially in the socket-shaped receiving area (55) in the extended state and thereby presses the gripper jaws (51a, 51b, 51c, 51d, 51e, 51f) outwards in a radial direction (R).

2. The Internal gripper according to claim 1, wherein the gripper jaws (51a, 51b, 51c, 51d, 51e, 51f) are circularly disposed relative to one another and perpendicularly to the axial direction (A) of the internal gripper (100), and wherein the gripper jaws (51a, 51b, 51c, 51d, 51e, 51f) are connected to one another via an annular base (52).

3. The Internal gripper according to claim 1, further comprising a gripper housing designed as a cap nut (80) and configured for the releasable connection of the gripper attachment (50) to the actuating cylinder (10).

4. (canceled)

5. The Internal gripper according to claim 1, wherein the socket-shaped receiving area (55) formed by the gripper jaws (51a, 51b, 51c, 51d, 51e, 51f) has a frustoconical contour at least in some first regions (56) of the socket-shaped receiving area (55).

6. The Internal gripper according to claim 5, wherein the socket-shaped receiving area formed by the gripper jaws furthermore has a second region (57) with a cylindrical contour, the second region (57) extending substantially linearly as viewed in the axial direction (A) of the internal gripper (100).

7. The Internal gripper according to claim 5, wherein the actuating element (11) is arranged along a direction of actuation of the actuating cylinder (10).

8. The Internal gripper according to claim 1, wherein movement of the actuating element (11) to the retracted state and the extended state is in a direction of a main axis of the actuating cylinder (10).

9. The internal gripper according to claim 2, further comprising a gripper housing designed as a cap nut (80) and configured for the releasable connection of the gripper attachment (50) to the actuating cylinder (10).

10. The internal gripper according to claim 2, wherein the socket-shaped receiving area (55) formed by the gripper jaws (51a, 51b, 51c, 51d, 51e, 51f) has a frustoconical contour at least in some first regions (56) of the socket-shaped receiving area (55).

11. The internal gripper according to claim 2, wherein movement of the actuating element (11) to the retracted state and the extended state is in a direction of a main axis of the actuating cylinder (10).

12. The internal gripper according to claim 3, wherein the socket-shaped receiving area (55) formed by the gripper jaws (51a, 51b, 51c, 51d, 51e, 51f) has a frustoconical contour at least in some first regions (56) of the socket-shaped receiving area (55).

13. The internal gripper according to claim 3, wherein movement of the actuating element (11) to the retracted state and the extended state is in a direction of a main axis of the actuating cylinder (10).

14. The internal gripper according to claim 5, wherein movement of the actuating element (11) to the retracted state and the extended state is in a direction of a main axis of the actuating cylinder (10).

15. The internal gripper according to claim 5, wherein the frustoconical contour has a taper angle (α) between 5 and 25 degrees.

16. The internal gripper according to claim 15, wherein the taper angle (α) is between 10 and 15 degrees.

17. The internal gripper according to claim 6, wherein movement of the actuating element (11) to the retracted state and the extended state is in a direction of a main axis of the actuating cylinder (10).

18. The internal gripper according to claim 6, wherein the actuating element (11) is arranged along a direction of actuation of the actuating cylinder (10).

19. The internal gripper according to claim 7, wherein movement of the actuating element (11) to the retracted state and the extended state is in a direction of a main axis of the actuating cylinder (10).
